(19) United States
(12) Patent Application Publication
(10) Pub. No.: US 2014/0003374 A1
(43) Pub. Date: Jan. 2, 2014

(54) METHOD AND APPARATUS FOR ENHANCING TTI (TRANSMISSION TIME INTERVAL) BUNDLING IN A WIRELESS COMMUNICATION NETWORK

(71) Applicant: Innovative Sonic Corporation, Taipei City (TW)

(72) Inventor: Richard Lee-Chee Kuo, Taipei City (TW)

(21) Appl. No.: 13/930,272

(22) Filed: Jun. 28, 2013

Related U.S. Application Data
(60) Provisional application No. 61/667,098, filed on Jul. 2, 2012.

(51) Int. Cl. H04L 1/18

(52) U.S. Cl. CPC H04L 1/1864
USPC 370/329; 370/328

(57) ABSTRACT

A method and apparatus are disclosed for enhancing TTI bundling in a wireless communication network. In one embodiment, the method includes a network node configuring a TTI bundling operation to a UE (User Equipment) for uplink transmissions, wherein a TB (Transport Block) is transmitted in a TTI bundle and the TTI bundle contains multiple subframes, and the network node transmits a HARQ (Hybrid Automatic Repeat and reQuest) ACK (Acknowledgement) to the UE for a transmission received within the TTI bundle if the transmitted TB is decoded successfully and the transmission is not the last transmission of the TTI bundle. In another embodiment, the method includes a network node configuring a TTI bundling operation to a UE (User Equipment) for uplink transmissions, wherein a TB (Transport Block) is transmitted in a TTI bundle and the TTI bundle contains multiple subframes, the network node transmits a PDCCH (Physical Downlink Control Channel) to the UE for triggering an adaptive retransmission within the TTI bundle, and the retransmission is not a first transmission of the TTI bundle.

### CROSS-REFERENCE TO RELATED APPLICATIONS

The present Application claims the benefit of U.S. Provisional Patent Application Ser. No. No. 61/667,098 filed on Jul. 2, 2012, the entire disclosure of which is incorporated herein by reference.

### FIELD

This disclosure generally relates to wireless communication networks, and more particularly, to a method and apparatus for enhancing TTI bundling in a wireless communication network.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for enhancing TTI bundling in a wireless communication network. In one embodiment, the method includes a network node configuring a TTI bundling operation to a UE (User Equipment) for uplink transmissions, wherein a TB (Transport Block) is transmitted in a TTI bundle and the TTI bundle contains multiple subframes, and the network node transmits a HARQ (Hybrid Automatic Repeat and reQuest) ACK (Acknowledgement) to the UE for a transmission received within the TTI bundle if the transmitted TB is decoded successfully and the transmission is not the last transmission of the TTI bundle. In another embodiment, the method includes a network node configuring a TTI bundling operation to a UE (User Equipment) for uplink transmissions, wherein a TB (Transport Block) is transmitted in a TTI bundle and the TTI bundle contains multiple subframes, the network node transmits a PDCCH (Physical Downlink Control Channel) to the UE for triggering an adaptive retransmission within the TTI bundle, and the retransmission is not a first transmission of the TTI bundle.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a message sequence chart according to one exemplary embodiment.

FIG. 6 is an illustration according to one exemplary embodiment.

FIG. 7 is a message sequence chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TR36.824-100, “E-UTRA LTE Coverage Enhancements (Release 11)”; R1-122866, “Text Proposal on solutions for LTE Coverage Enhancements”; TS 36.321 V10.5.0, “E-UTRA MAC protocol specification (Release 10)”; and TS 36.331 V 10.5.0, “E-UTRA RRC protocol specification (Release 10)”. The standards and documents listed above are hereby expressly incorporated herein.

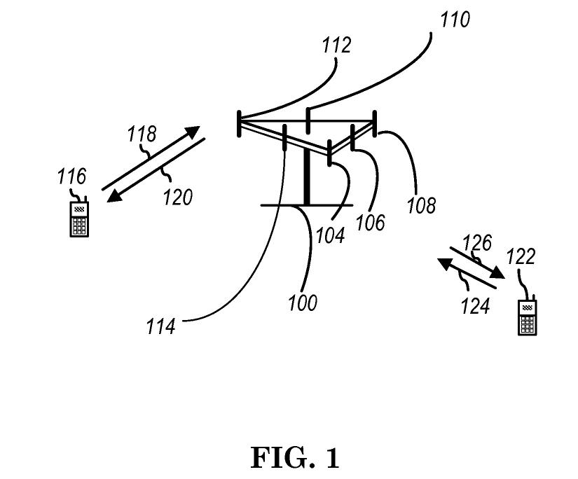

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

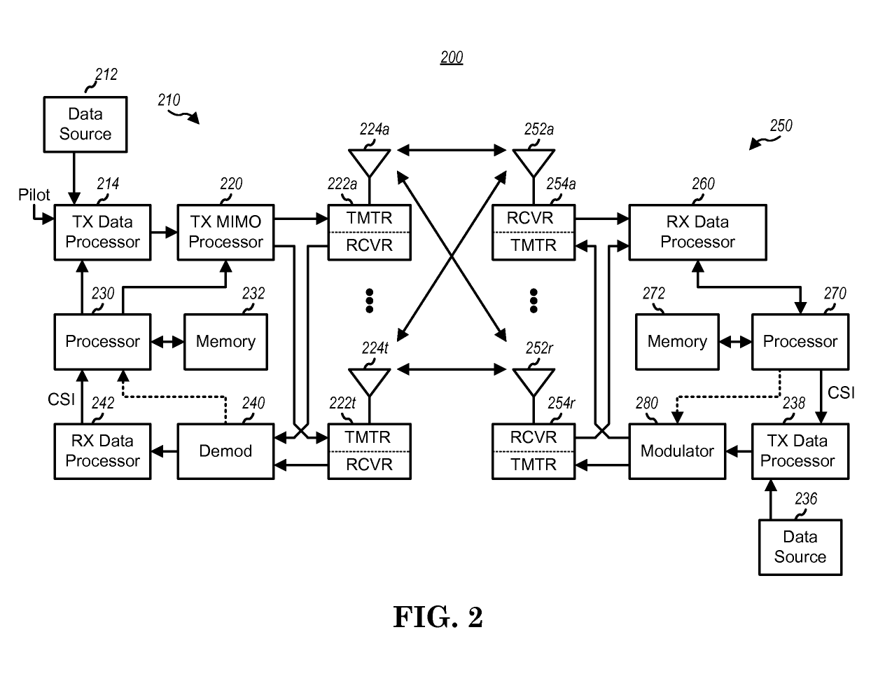

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

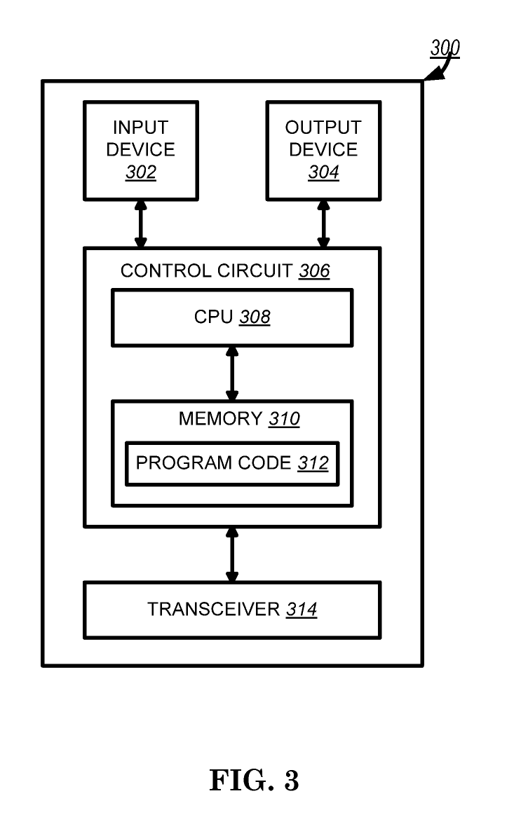

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

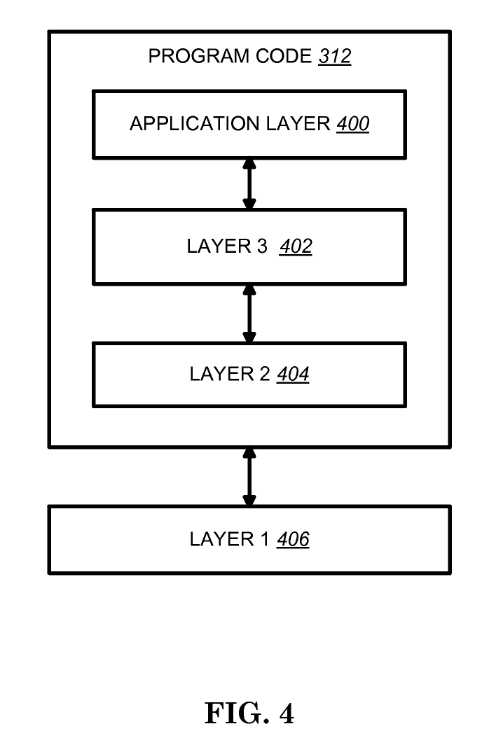

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TR36.824-100 collects the work done under the Study Item “LTE Coverage Enhancements”. According to this technical report, the first priority of the Study Item is identifying the limiting channel(s)/direction between the various LTE data and control channels in UL (Uplink) and DL (Downlink). VoIP (Voice Over Internet Protocol) and medium data rate are two services to consider. It is agreed to further investigate TTI bundling enhancements for both medium data rate and VoIP in UL.

In addition, 3GPP R1-122866 captures the agreements reached in RAN1#69 meeting. Section 6 of 3GPP R1-122866 describes the current TTI bundling operation and points out the restrictions of the current TTI bundling operation as follows:

6 Solutions for Coverage Enhancements TTI bundling is specified as follows in Release 8/9/10 to improve UL coverage:
A single transport block is channel coded and transmitted in a set of 4 consecutive TTIs.
The bundled TTIs are treated as a single UL resource assignment where a single UL grant and a single PHICH ACK/NACK are required.
TTI bundling is activated through RRC.
HARQ RTT and HARQ process of TTI bundling are specified.

In the Release 8/9/10 specifications, the TTI bundling mechanism is restricted to bundles of 4 TTIs, QPSK modulation and to allocations up to 3 PRBs. For VoIP, these constraints leave some room to further improve the amount of energy transmitted per information bit, and thus the coverage. Higher data rate services can potentially benefit from reduced overhead and larger coding gain resulting from larger transport block sizes associated with TTI bundling. These constraints impose restrictions on the support of large packet sizes, thus limiting the benefit for data services.

It is agreed to further investigate TTI bundling enhancements for both medium data rate and VoIP in UL. The following potential enhancements have been identified.

Furthermore, Section 6.2 of 3GPP R1-122866 describes TTI bundling enhancements for UL VoIP as follows:

### 6.2 TTI Bundling Enhancements for UL VoIP

### 6.2.1 Description

Given the fixed arrival rate of voice packets, TTI bundling enhancements for VoIP can improve the time resource utilization so that more energy can be accumulated for a voice packet within the delay budget. Candidate solutions are as follows:

Reduced Round Trip Time
Reduced round trip time can bring benefits for more energy accumulation for VoIP within given delay budget.

Extended Bundle Size
Another candidate to accumulate more energy for VoIP within given delay budget is to extend the bundle size. The bundle size could be fixed or flexible.

Enhanced Method to Increase the Time Diversity
Bundled TTIs can be interleaved in time, so that PUSCH transmission spans over longer time.

Addition of Spreading
TTI bundling with retransmissions involves repeating the coded bits. An alternative way of achieving repetition is to use spreading, which has the additional benefit of increasing the robustness with respect to interference. A similar structure as PUCCH format 3 could be used in order to add the spreading dimension.

It is for further study to extend TTI bundling to more TDD DL/UL configurations.

TTI bundling enhancements may take into account of improvement of diversity and channel estimation accuracy.

Furthermore, 3GPP TS36.321-a50 describes and specifies of the current TTI bundling operation as follows:

### 5.4.2.1 HARQ Entity

When TTI bundling is configured, the parameter TTI_BUNDLE_SIZE provides the number of TTIs of a TTI bundle. TTI bundling operation relies on the HARQ entity for invoking the same HARQ process for each transmission that is part of the same bundle. Within a bundle HARQ retransmissions are non-adaptive and triggered without waiting for feedback from previous transmissions according to TTI_BUNDLE_SIZE. The HARQ feedback of a bundle is only received for the last TTI of the bundle (i.e the TTI corresponding to TTI_BUNDLE_SIZE), regardless of whether a transmission in that TTI takes place or not (e.g. when a measurement gap occurs). A retransmission of a TTI bundle is also a TTI bundle. TTI bundling is not supported when the UE is configured with one or more SCells with configured uplink.

In the current TTI bundling operation (as described and specified in 3GPP TR36.824-100 and TS 36.321 V10.5.0), the bundle size is 4 subframes and the HARQ (Hybrid Automatic Repeat and reQuest) feedback of a bundle is only received for the last TTI of the bundle. Extended bundle size is now considered a candidate solution of TTI bundling enhancements for uplink VoIP in Rel-11. Bundle sizes of 8, 10, and 20 subframes have been discussed. Given the scheme of extended bundle size, further TTI bundling enhancement on HARQ feedback of a bundle could be considered.

In general, eNB may be able to decode the uplink transport block (TB) successfully within transmission period of a bundle. In this situation, if the bundle size is greater than four (4) subframes, it would be beneficial for eNB to transmit an HARQ ACK to the UE so that the remaining transmissions of a bundle can be suspended. In addition, for a bundle size of four (which is used in the current standard), HARQ feedback for transmissions within a bundle would not help because all transmissions of the bundle have been finished even when the first HARQ feedback is received. Suspending the remaining transmissions of a bundle would result in UE power saving and system interference reduction. Also, the relevant radio resource could be reallocated to other UEs. As a result, performance of TTI bundling transmission would be enhanced.

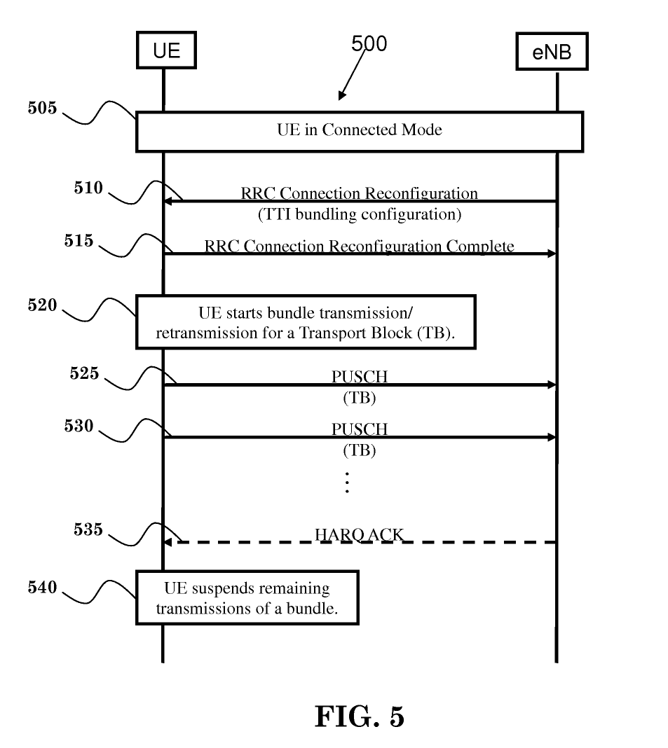

FIG. 5 is a message sequence chart 500 in accordance with one exemplary embodiment. In step 505, the UE (User Equipment) is in Connected Mode. In step 510, eNB (evolved Node B) transmits a TTI bundling configuration via a RRC (Radio Resource Control) Connection Reconfiguration message to the UE to configure TTI bundling for uplink transmissions. In step 515, the UE sends a RRC Connection Reconfiguration Complete message to eNB. In step 520, the UE starts a bundle transmission or retransmission for a TB (Transport Block). In steps 525 and 530, the UE transmits the TB to eNB via the PUSCH (Physical Uplink Shared Channel). In step 535, eNB sends a HARQ ACK (Acknowledgement) to the UE in response to successful reception of the TB within the bundle. The UE then suspends the remaining transmissions of the current bundle in step 540.

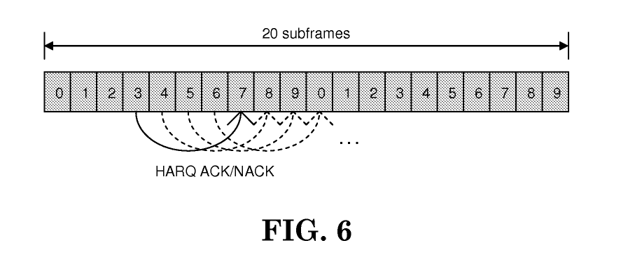

FIG. 6 is an illustration in accordance with one exemplary embodiment. A bundle size of twenty (20) subframes is assumed in this figure. A way of HARQ feedback for transmissions within a bundle includes starting HARQ feedback after certain transmissions of a bundle. In FIG. 6, eNB starts HARQ feedback after four (4) transmissions of a bundle. The eNB may start HARQ feedback right from receiving the first transmission of a bundle. But, the probability for the eNB to successfully decode the TB based on one single transmission from the UE would be low. For example, let's assume the eNB successfully decodes the TB after receiving four (4) transmissions from the UE. Then, the HARQ feedbacks of NACK for the earlier three (3) transmissions were not needed. Thus, starting HARQ feedback after certain transmissions of a bundle is more signaling efficient because less HARQ feedbacks are transmitted.

Referring back to FIGS. 3 and 4, the device 300 includes a program code 312 stored in memory 310. In one embodiment, the CPU 308 could execute the program code 312 to enable a network node to configure a TTI bundling operation to a UE (User Equipment) for uplink transmissions, wherein a TB (Transport Block) is transmitted in a TTI bundle and the TTI bundle contains multiple subframes, and the network node transmits a HARQ (Hybrid Automatic Repeat and reQuest) ACK (Acknowledgement) to the UE for a transmission received within the TTI bundle if the transmitted TB is decoded successfully and the transmission is not the last transmission of the TTI bundle.

In one embodiment, the subframes of the TTI bundle could be consecutive. Furthermore, the TTI bundle could include more than four (4) subframes.

In addition, the CPU 308 can execute the program code 312 to perform all of the above-described actions and steps or others described herein.

Also, in the current TTI bundling operation (as described and specified in 3GPP TR36.824-100 and TS 36.321 V10.5.0), a single uplink grant could be applied for all transmissions of a bundle and all HARQ retransmissions within a bundle are non-adaptive. For extended bundle sizes of 8, 10, and 20 (subframes), the total period for transmitting a bundle would be much longer than before. During this transmission period, the radio condition may vary a great deal. Thus, it may not be proper in terms of transmission performance of a bundle to use the same uplink grant for all transmissions of a bundle.

To improve the transmission performance of a bundle, multiple uplink grants could be applied for transmitting a bundle. In general, one potential solution is to allow adaptive retransmissions within a bundle. There are two alternatives: (1) an adaptive grant may be transmitted for each retransmission generated after certain transmissions of the bundle, and (2) an adaptive grant may be transmitted once every certain transmissions of the bundle.

Another solution is to provide two uplink grants in a PDCCH for bundle transmissions. Furthermore, these two uplink grants may be applied alternately for two consecutive transmissions. As a result, performance of TTI bundling transmission would be enhanced.

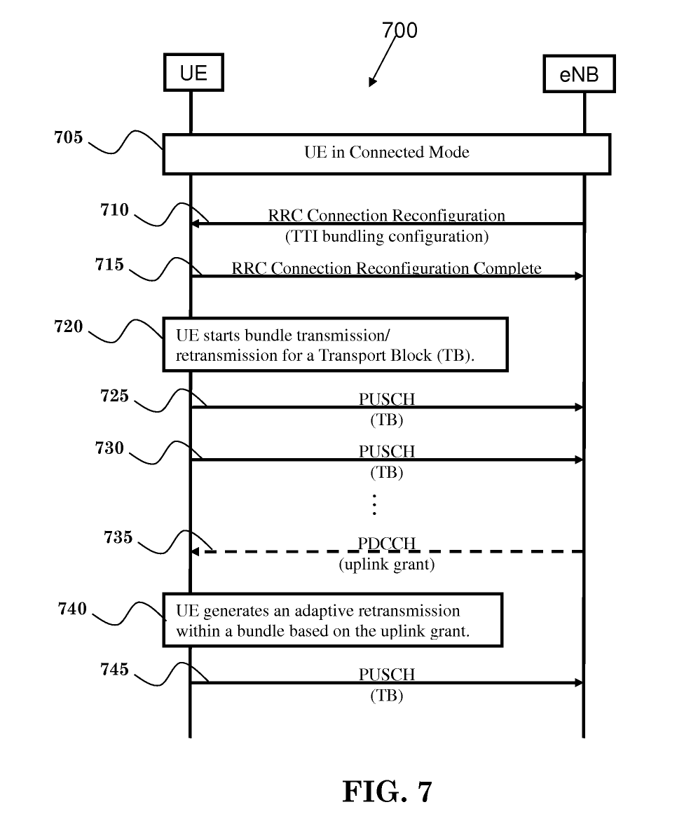

FIG. 7 is a message sequence chart 700 in accordance with one exemplary embodiment. In step 705, the UE (User Equipment) is in Connected Mode. In step 710, eNB (evolved Node B) transmits a TTI bundling configuration via a RRC (Radio Resource Control) Connection Reconfiguration message to the UE to configure TTI bundling for uplink transmissions. In step 715, the UE sends a RRC Connection Reconfiguration Complete message to eNB. In step 720, the UE starts a bundle transmission or retransmission for a TB (Transport Block). In steps 725 and 730, the UE transmits the TB to eNB via the PUSCH (Physical Uplink Shared Channel). In step 735, eNB sends an UL grant via the PDCCH (Physical Downlink Control Channel) to the UE. In step 740, the UE generates an adaptive retransmission within a bundle based on the received UL grant. In step 745, the UE retransmits the TB via the PUSCH.

Referring back to FIGS. 3 and 4, the device 300 includes a program code 312 stored in memory 310. In one embodiment, the CPU 308 could execute the program code 312 to enable a network node to configure a TTI bundling operation to a UE (User Equipment) for uplink transmissions, wherein a TB (Transport Block) is transmitted in a TTI bundle and the TTI bundle contains multiple subframes, the network node transmits a PDCCH (Physical Downlink Control Channel) to the UE for triggering an adaptive retransmission within the TTI bundle, and the retransmission is not a first transmission of the TTI bundle.

In one embodiment, the PDCCH carries an uplink grant for a retransmission within the bundle. Furthermore, the subframes of the TTI bundle could be consecutive. In addition, the TTI bundle could include more than four (4) subframes.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other faun of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for enhancing TTI (Transmission Time Interval) bundling, comprising:
a network node configures a TTI bundling operation to a UE (User Equipment) for uplink transmissions,
wherein a TB (Transport Block) is transmitted in a TTI bundle and the TTI bundle contains multiple subframes, and
the network node transmits a HARQ (Hybrid Automatic Repeat and reQuest) ACK (Acknowledgement) to the UE for a transmission received within the TTI bundle if the transmitted TB is decoded successfully and the transmission is not the last transmission of the TTI bundle.

2. The method of claim 1, wherein the subframes of the TTI bundle are consecutive.

3. The method of claim 1, wherein the TTI bundle contains more than four (4) subframes.

4. A method for enhancing TTI (Transmission Time Interval) bundling, comprising:
a UE (User Equipment) is configured with a TTI bundling operation by a network node for uplink transmissions,
wherein a TB (Transport Block) is transmitted in a TTI bundle and the TTI bundle contains multiple subframes, and
the UE receives a HARQ (Hybrid Automatic Repeat and reQuest) ACK (Acknowledgement) from the network node for a transmission received within the TTI bundle if the transmitted TB is decoded successfully and the transmission is not the last transmission of the TTI bundle.

5. The method of claim 4, wherein the subframes of the TTI bundle are consecutive.

6. The method of claim 1, wherein the TTI bundle contains more than four (4) subframes.

7. A method for enhancing TTI (Transmission Time Interval) bundling, comprising:
a network node configures a TTI bundling operation to a UE (User Equipment) for uplink transmissions,
wherein a TB (Transport Block) is transmitted in a TTI bundle and the TTI bundle contains multiple subframes,
the network node transmits a PDCCH (Physical Downlink Control Channel) to the UE for triggering an adaptive retransmission within the TTI bundle, and
the retransmission is not a first transmission of the TTI bundle.

8. The method of claim 7, wherein the PDCCH carries an uplink grant for a retransmission within the TTI bundle.

9. The method of claim 7, wherein the subframes of the TTI bundle are consecutive.

10. The method of claim 7, wherein the TTI bundle contains more than four (4) subframes.

11. A method for enhancing TTI (Transmission Time Interval) bundling, comprising:
a UE is configured with a TTI bundling operation by a network node for uplink transmissions,
wherein a TB (Transport Block) is transmitted in a TTI bundle and the TTI bundle contains multiple subframes,
the UE receives a PDCCH (Physical Downlink Control Channel) from the network node for triggering an adaptive retransmission within the TTI bundle, and
the retransmission is not a first transmission of the TTI bundle.

12. The method of claim 11, wherein the PDCCH carries an uplink grant for a retransmission within the TTI bundle.

13. The method of claim 11, wherein the subframes of the TTI bundle are consecutive.

14. The method of claim 11, wherein the TTI bundle contains more than four (4) subframes.
